(19) United States
(12) Patent Application Publication
(10) Pub. No.: US 2016/0102987 A1
(43) Pub. Date: Apr. 14, 2016

(54) METHOD FOR INFERRING TYPE OF ROAD SEGMENT

(71) Applicant: Guangzhou HKUST Fok Ying Tung Research Institute, Guangzhou (CN)

(72) Inventors: Ye Ding, Guangzhou (CN); Haoyu Tan, Guangzhou (CN); Min Gao, Guangzhou (CN); Lionel M. Ni, Guangzhou (CN)

(73) Assignee: GUANGZHOU HKUST FOK YING TUNG RESEARCH INSTITUTE

(21) Appl. No.: 14/555,743

(22) Filed: Nov. 28, 2014

(30) Foreign Application Priority Data
Oct. 14, 2014 (CN) 201410542082.2

(51) Int. Cl. G01C 21/32; G07C 5/08; G07C 5/00

(52) U.S. Cl. CPC G01C 21/32; G07C 5/002; G07C 5/085

(57) ABSTRACT

Present invention provides a method for inferring the type of a road segment, comprising the steps of: collecting historical driving trajectory data of a plurality of vehicles for a target road segment, performing a statistic on the historical driving trajectory data, and obtaining statistical features of the target road segment; extracting topological features of the target road segment from topological structure data of the road network; merging the statistical features with the topological features of the target road segment, and obtaining an arrogated feature vector of the target road segment; building a logistic regression model according to the arrogated feature vector, and obtaining a first inferred type of the target road segment. The present embodiment considers both the driving trajectory data of a plurality of vehicles and the topological structure data of the road network, the accuracy of the present invention is high, and the inferred result is accurate.

### CROSS-REFERENCE TO RELATED APPLICATIONS

The present application claims the benefit of Chinese Patent Application No. 201410542082.2 filed on Oct. 14, 2014, the contents of which are hereby incorporated by reference.

### FIELD OF THE INVENTION

The present invention generally relates to crowdsourced map data processing technology, especially relates to a method for inferring a type of a road segment.

### BACKGROUND OF THE INVENTION

In recent years, crowdsourced map service has become a powerful competitor to public and commercial map service providers such as Google Maps. Different from commercial map services in which maps are produced from remote sensing images and survey data by a small group of professionals, crowdsourced maps are maintained by tens of thousands of registered users who continuously create and update maps using sophisticated map editors. Therefore, crowdsourced map services can be better in keeping up with recent map changes than existing commercial map services. For instance, it has been reported that OpenStreetMap (OSM), the world's largest crowdsourced mapping project, can provide richer and more timely-updated map data than comparable proprietary datasets.

Similar to other crowdsourcing applications, crowdsourced map services rely on lots of volunteered works which are error-prone and can have severe consistency problems. In fact, providing quality maps is far more challenging than most crowdsourcing applications such as reCAPTCHA. One major reason is that map objects (e.g., roads and regions) are usually complex, which makes it difficult to make map editors both feature-rich and user-friendly. To address this issue, a recent work proposed a map updating system called CrowdAtlas to probe map changes via a large number of historical taxi trajectories. CrowdAtlas reduces the cost of drawing roads by generating the shapes of new/changed roads from trajectories automatically.

To make the map data more useful for widely-used applications such as navigation systems and travel planning services, it is important to provide not only the topology of the road network and the shapes of the roads, but also the types of each road segment (e.g., highway, regular road, secondary way, etc.). Wherein, one road usually includes several road segments that may be different types. On the other hand, to reduce the cost of manual map editing, it is desirable to generate proper recommendations for users to choose from or conduct further modifications.

Existing works only focus on generating the shapes of roads automatically. However, the metadata of roads is also important to many map-based applications such as navigation systems and travel planning services. Typical metadata of roads includes width, speed limit, direction restriction and access limit. These metadata can be effectively reflected by the type of road segments, which often includes: motorway, primary/secondary way, residential road, etc. For example, the speed limit is often higher of a motorway than a secondary way; a motorway or a primary way is often a two-way street, while a residential road may be a single-way street. Therefore, to contribute to a quality crowdsourced map service, users need to provide not only the shapes of the roads, but also the types of the roads. Consequently, to further reduce the cost of updating crowdsourced maps for users, it is necessary to automate the process of labeling road types. The types may be directly inferred from the topology of the road network, e.g., road segments with the same direction may have the same type. However, it is often not accurate.

### SUMMARY OF THE INVENTION

In view of it, the present invention provides a method for inferring a type of a road segment with a higher accuracy.

In order to achieve the purpose, the present invention provides a method for inferring a type of a road segment, comprising the steps of:

collecting historical driving trajectory data of a plurality of vehicles for a target road segment, performing a statistic on the historical driving trajectory data, and obtaining statistical features of the target road segment;

extracting topological features of the target road segment from the topological structure data of a road network in which the target road segment locates;

merging the statistical features with the topological features of the target road segment and obtaining an arrogated feature vector of the target road segment; and

building a logistic regression model according to the arrogated feature vector, and obtaining a first inferred type of the target road segment.

Ulteriorly, after the steps of building the logistic regression model according to the arrogated feature vector and obtaining the first inferred type of the target road segment, the method further comprises the steps of:

obtaining a connection angle between the target road segment and its neighboring road segment from the topological structure data of the road network; and

obtaining a second inferred type of the target road segment based on the obtained connection angle and the type of the neighboring road segment.

Ulteriorly, after the step of obtaining the second inferred type of the target road segment, the method further comprises the steps of:

adopting an integrated algorithm to compute a final inferred type of the target road segment according to the first inferred type and the second inferred type of the target road segment.

Wherein the steps of collecting historical driving trajectory data of the plurality of vehicles for the target road segment, performing the statistic on the historical driving trajectory data, and obtaining the statistical features of the target road segment comprises the steps of:

collecting historical driving trajectory data of the plurality of vehicles;

adopting a ST-Matching algorithm to match the historical driving trajectory data onto the road network, and obtaining the historical driving trajectory data of the target road segment; and

performing the statistic on the historical driving trajectory data of the target road segment, thereby obtaining the statistical features of the target road segment.

Ulteriorly, after the steps of merging the statistical features with the topological features of the target road segment and obtaining the arrogated feature vector of the target road segment, the method further comprises the steps of:

adopting a principal component analysis to reduce the dimensionality of the arrogated feature vector, and obtaining principal components of the arrogated feature vector.

Ulteriorly, after the step of obtaining the connection angle between the target road segment and its neighboring road segment from the topological structure data of the road network, the method further comprises the step of:

adopting a Bayes classifier to learn and thus to obtain a polynomial distribution, based on a road segment whose type have been known and the topological structure data of the road network; wherein, the polynomial distribution represents the probability distribution of a road segment type by a function that depends on the connection angle between the road segment and its neighboring road segment and the type of its neighboring road segment.

Wherein the step of obtaining the second inferred type of the target road segment based on the obtained connection angle and the type of the neighboring road segment comprises the step of:

adopting Bayesian algorithm to compute the second inferred type by using the polynomial distribution according to the obtained connection angle and the types of the neighboring road segment of the target road segment.

The present embodiment provides a method for inferring a type of a road segment, comprising the steps of: collecting the historical driving trajectory data of the plurality of vehicles for the target road segment, and then performing the statistic on the historical driving trajectory data, and obtaining the statistical features of the target road segment; extracting the topological features of the target road segment from the topological structure data of the road network; merging the statistical features with the topological features of the target road segment, and obtaining the arrogated feature vector of the target road segment; building the logistic regression model according to the arrogated feature vector, and obtaining the first inferred type of the target road segment. The present embodiment considers both the driving trajectory data of the plurality of vehicles and the topological structure data of the road network, so that the accuracy of present invention is high, and the inferred result is more accurate.

### BRIEF DESCRIPTION OF THE DRAWINGS

To describe the technical solutions in the embodiments of the present invention more clearly, the following briefly introduces the accompanying drawings needed for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of a method for inferring a type of a road segment according to one embodiment of the present invention.

FIG. 2 shows the data type of sample points of historical trajectories.

FIG. 3 shows two adjacent road segments.

FIG. 4 shows the types of road segments.

FIG. 5 is a flowchart of a method for inferring a type of a road segment according to another embodiment of the present invention.

FIG. 6 is a flowchart of a method for inferring a type of a road segment according to another embodiment of the present invention.

### DETAILED DESCRIPTION OF ILLUSTRATED EMBODIMENTS

The technical solutions in the embodiments of the present invention are clearly and completely described in the following with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

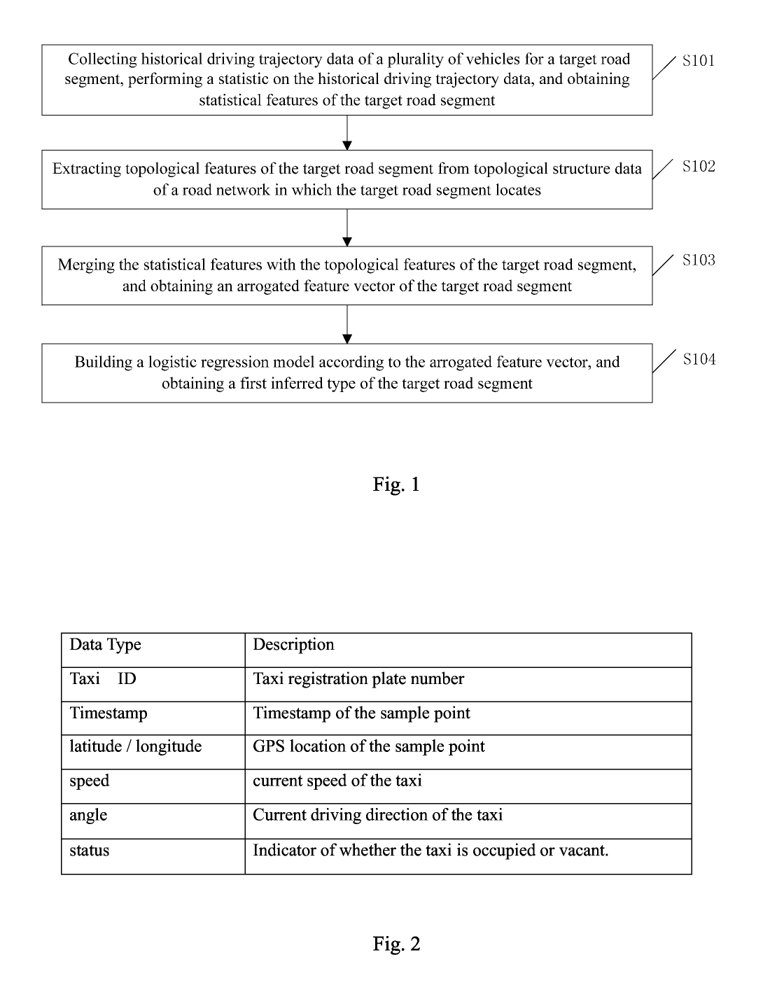

FIG. 1 is a flowchart of a method for inferring a type of a road segment according to one embodiment of the present invention. As shown in FIG. 1, this method comprises the steps of:

S101: Collecting historical driving trajectory data of a plurality of vehicles for a target road segment, performing a statistic on the historical driving trajectory data, and obtaining statistical features of the target road segment.

Concretely, the S101 includes the steps of: collecting the historical driving trajectory data of the plurality of vehicles for the target road segment; adopting the ST-Matching algorithm to match the historical driving trajectory data of the plurality of vehicles onto the road network, and obtaining the historical driving trajectory data of the target road segment; performing the statistic on the historical driving trajectory data of the target road segment, thereby obtaining statistical features of the target road segment.

A road segment is the carriageway between two intersections. An expressway or a large avenue may have two different road segments between two intersections, because they are different directions with limited-access.

Wherein, the a plurality of vehicles specifically refers to a plurality of taxis. It is understandable, the vehicles can also be other types of cars, such as buses, private vehicles and so on. Since it is private and difficult to obtain private vehicle data, this embodiment uses the historical trajectories of taxis. A trajectory is represented as a series of sample points, wherein the sampling rate is around 20 seconds. As shown in FIG. 2, the data of each sample point includes taxi ID, timestamp, latitude/longitude, speed, angle, and status. Wherein, the taxi ID is the taxi registration plate number; the timestamp is timestamp of the sample point; the latitude/longitude is the GPS location of the sample point; the speed is the current speed of the taxi while sampling; the angle is the current driving direction of the taxi while sampling; the status is the indicator of whether the taxi is occupied or vacant.

Wherein, the GPS location of the sample point is represented as a latitude-longitude pair with timestamp, without any road network information. Hence, we have to map the trajectories onto the road network via map matching. The present embodiment uses the method ST-Matching proposed in Page 352˜361 of International Journal of Geographical Information Science (2009). ST-Matching considers both the spatial topological structure of the road network, and the temporal features of the trajectories. ST-Matching is suitable to handle low-sampled trajectories, such like the taxi trajectories in this embodiment.

After mapping the historical trajectories onto the road network, obtains the data of sample points that belongs to the target road segment. Then performs a statistic of the data of sample points, and obtains the statistical features of the target road segment. Wherein, the statistical features include average speed of occupied taxis, density of occupied taxis, density of vacant taxis, and number of pick-up events. That is, the statistical features of the target road segment are got by doing statistics of the taxi ID, timestamp, latitude/longitude, speed, angle, and status of a set of sample points.

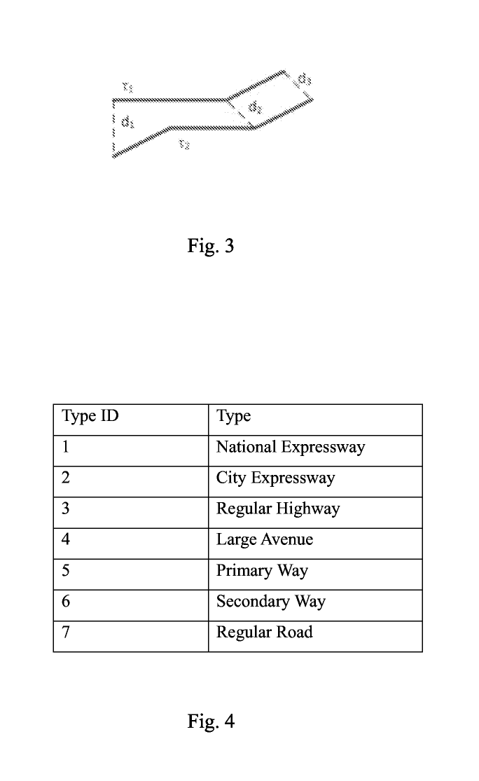

S102: Extracting topological features of the target road segment from topological structure data of a road network in which the target road segment locates.

Wherein, the topological structure data of the road network has been known. A road network {τᵢ}ᵢ₌₁ⁿ consists of a set of road segments, where τᵢ is road segment i. This invention uses a connectivity matrix M^{n×n} to represent the topology of the road network, where mᵢⱼ∈M is the normalized angle between road segments i and j if they are connected, and 0 otherwise.

Wherein, the topological features of the target road segment include length of road segment, cumulative flutter value, neighbors, and adjacent road segments. Wherein, length of road segment and cumulative flutter value can effectively show the type of a road segment. For example, a large avenue is often limited-access, and there are few intersections within it during a long distance. Hence, a road segment with long length is more likely to be a large avenue, or an expressway. Similarly, a road segment is more likely to be a large avenue when it is straighter, and less when it is twisted, based on our experience. Hence, this invention uses cumulative flutter value to show the types of road segments. For the neighbors, it is considered that two road segments are neighbors when they are topologically connected. If a road segment has a plurality of neighbors, it is less likely to be a large avenue, because a large avenue, or an expressway, often has one or two neighbors as the entrance/exit of it. For the adjacent road segments, “adjacent” is defined as the distance between two road segments is less than a preset threshold (specially a small distance, such as 10 meters). The distance of two road segments is calculated via the average distance between each vertex of the polylines of the road segments. As shown in FIG. 3, τᵢ is the road segment 1, τ₂ is the road segment 2. The distance between the vertexes of two road segments are d₁, d₂, d₃, then the average of d₁, d₂, d₃ is the distance of two road segments. Two adjacent road segments may have the same type especially when they have opposite directions.

S103: Merging the statistical features with the topological features of the target road segment, and obtaining an arrogated feature vector of the target road segment.

Specifically, the statistical features and the topological features constitute the arrogated feature vector. Since the size of the collected data may be large, the dimensionality of the arrogated feature vector may be large. So after the step S103, the invention can further comprise the step: adopting a principal component analysis to reduce the dimensionality of the arrogated feature vector, and obtaining principal components of the arrogated feature vector.

S104: Building a logistic regression model according to the arrogated feature vector and obtaining a first inferred type of the target road segment.

Wherein, the types of road segments are defined according to the regulations of the national standard. As shown in FIG. 4, the types of road segments include 7 types. Wherein the first inferred type is the outputted result of logistic regression model.

The present embodiment provides a method for inferring a type of a road segment, comprising the steps of: collecting the historical driving trajectory data of the plurality of vehicles for the target road segment, performing the statistic on the historical driving trajectory data, and obtaining the statistical features of the target road segment; extracting the topological features of the target road segment from the topological structure data of the road network; merging the statistical features with the topological features of the target road segment, and obtaining the arrogated feature vector of the target road segment; building the logistic regression model according to the arrogated feature vector, and obtaining the first inferred type of the target road segment. The present embodiment considers both the driving trajectory data of the plurality of vehicles and the topological structure data of the road network, so that the accuracy of the present invention is high, and the inferred result is more accurate.

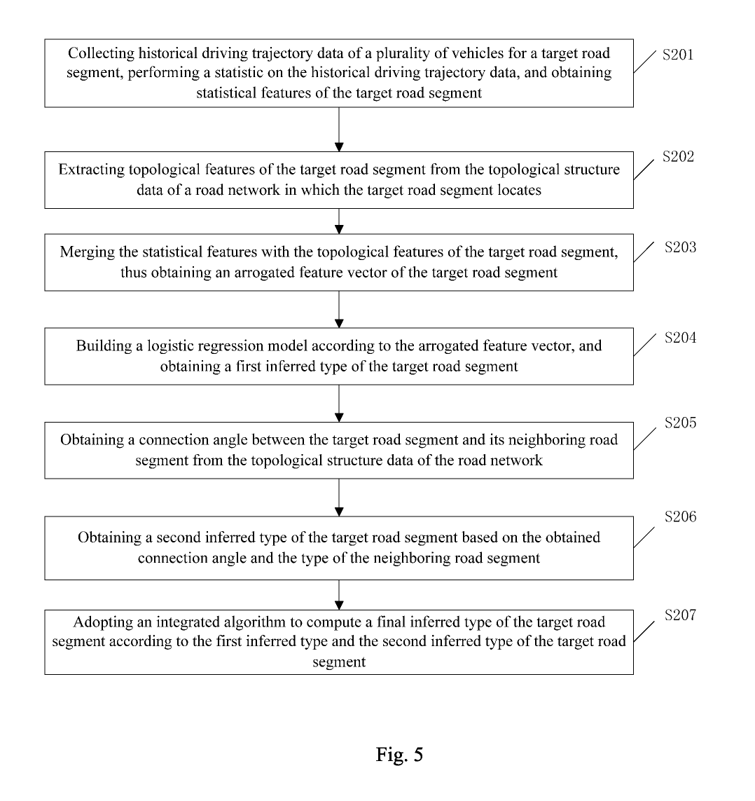

FIG. 5 is a flowchart of a method for inferring a type of a road segment according to another embodiment of the present invention. As shown in FIG. 5, this method comprises the steps of:

S201: Collecting historical driving trajectory data of a plurality of vehicles for a target road segment, performing a statistic on the historical driving trajectory data, and obtaining statistical features of the target road segment.

Concretely, the S201 comprises the steps of: collecting the historical driving trajectory data of the plurality of vehicles for the target road segment; adopting the ST-Matching algorithm to match the historical driving trajectory data of the plurality of vehicles onto the road network, and obtaining the historical driving trajectory data for the target road segment; performing the statistic on the historical driving trajectory data of the target road segment, thereby obtaining statistical features of the target road segment.

A road segment is the carriageway between two intersections. An expressway or a large avenue may have two different road segments between two intersections, because they are different directions with limited-access.

Wherein, the a plurality of vehicles specifically refers to a plurality of taxis. It is understandable, the vehicles can also be other types of cars, such as buses, private vehicles and so on. Since it is private and difficult to obtain private vehicle data, this embodiment uses the historical trajectories of taxis. A trajectory is represented as a series of sample points, wherein the sampling rate is around 20 seconds. As shown in FIG. 2, the data of each sample point includes taxi ID, timestamp, latitude/longitude, speed, angle, and status. Wherein, the taxi ID is the taxi registration plate number; the timestamp is timestamp of the sample point; the latitude/longitude is the GPS location of the sample point; the speed is the current speed of the taxi while sampling; the angle is the current driving direction of the taxi while sampling; the status is the indicator of whether the taxi is occupied or vacant.

Wherein, the GPS location of the sample point is represented as a latitude-longitude pair with timestamp, without any road network information. Hence, we have to map the trajectories onto the road network via map matching. The present embodiment uses the method ST-Matching proposed in Page 352˜361 of International Journal of Geographical Information Science (2009). ST-Matching considers both the spatial topological structure of the road network, and the temporal features of the trajectories. ST-Matching is suitable to handle low-sampled trajectories, such like the taxi trajectories in this embodiment.

After mapping the historical trajectories onto the road network, obtains the data of sample points that belongs to the target road segment. Then performs a statistic of the data of sample points, and obtains the statistical features of the target road segment. Wherein, the statistical features include an average speed of occupied taxis, a density of occupied taxis, a density of vacant taxis, and the number of pick-up events. That is, the statistical features of the target road segment are got by doing statistics of the taxi ID, timestamp, latitude/longitude, speed, angle, and status of a set of sample points.

S202: Extracting topological features of the target road segment from topological structure data of a road network in which the target road segment locates.

Wherein, the topological structure data of the road network has been known. A road network {τᵢ}ᵢ₌₁ⁿ consists of a set of road segments, where τᵢ is road segment i. This invention uses a connectivity matrix M^{n×n} to represent the topology of the road network, where mᵢⱼ∈M is the normalized angle between road segments i and j if they are connected, and 0 otherwise.

Wherein, the topological features of the target road segment include length of road segment, cumulative flutter value, neighbors, and adjacent road segments. Wherein, length of road segment and cumulative flutter value can effectively show the type of a road segment. For example, a large avenue is often limited-access, and there are few intersections within it during a long distance. Hence, a road segment with long length is more likely to be a large avenue, or an expressway. Similarly, a road segment is more likely to be a large avenue when it is straighter, and less when it is twisted, based on our experience. Hence, this invention uses cumulative flutter value to show the types of road segments. For the neighbors, it is considered that two road segments are neighbors when they are topologically connected. If a road segment has a plurality of neighbors, it is less likely to be a large avenue, because a large avenue, or an expressway, often has one or two neighbors as the entrance/exit of it. For the adjacent road segments, “adjacent” is defined as the distance between two road segments is less than a preset threshold (specially a small distance, such as 10 meters). The distance of two road segments is calculated via the average distance between each vertex of the polylines of the road segments. As shown in FIG. 3, τᵢ is the road segment 1, τ₂ is the road segment 2. The distance between the vertexes of two road segments are d₁, d₂, d₃, then the average of d₁, d₂, d₃ is the distance of two road segments. Two adjacent road segments may have the same type especially when they have opposite directions.

S203: Merging the statistical features with the topological features of the target road segment, and obtaining an arrogated feature vector of the target road segment.

Specifically, the statistical features and the topological features constitute the arrogated feature vector. Since the size of the collected data may be large, the dimensionality of the arrogated feature vector may be large. So after the step S203, the invention can further comprise the step: adopting a principal component analysis to reduce the dimensionality of the arrogated feature vector, and obtaining principal components of the arrogated feature vector.

S204: Building a logistic regression model according to the arrogated feature vector, and obtaining a first inferred type of the target road segment.

Wherein, the types of road segments are defined according to the regulations of the national standard. As shown in FIG. 4, the types of road segments include 7 types. Wherein the first inferred type is the outputted result of logistic regression model.

However, if there is only a small moment of arrogated feature vector data, the first inferred type may not be vaccurate, so the present embodiment adopts the connection angle as a basis.

S205: Obtaining a connection angle between the target road segment and its neighboring road segment from the topological structure data of the road network.

Generally, it is observed that the type of a particular road segment has a strong indication of the possible types that its neighboring road segments can take, depending on the connection angles. The connection angle of two neighboring road segments highly determines the relation of the types of these two road segments. For example, in a common urban road network, if two road segments have an angle of 180°, they are often the same road with the same road name. When the angle becomes smaller, like 90°, they are often two different roads with different road names.

S206: Obtaining a second inferred type of the target road segment based on the obtained connection angle and the type of the neighboring road segment.

Wherein, the second inferred type is the second preliminary result that is inferred based on the obtained connection angles and the types of the neighboring road segments.

S207: Adopting an integrated algorithm to compute a final inferred type of the target road segment according to the first inferred type and the second inferred type of the target road segment.

Wherein, the integrated algorithm is an algorithm that integrates the inferred results. In the present embodiment, the integrated algorithm is any one of Stacked generalization algorithm, Support Vector Machine algorithm and random forests algorithm. The final inferred type is obtained by synthesizing the first inferred type and the second inferred type.

The present embodiment provides a method for inferring a type of a road segment, comprising the steps of: collecting the historical driving trajectory data of the plurality of vehicles for the target road segment, performing the statistic on the historical driving trajectory data, and obtaining the statistical features of the target road segment; extracting the topological features of the target road segment from the topological structure data of the road network; merging the statistical features with the topological features of the target road segment, and obtaining the arrogated feature vector of the target road segment; building the logistic regression model according to the arrogated feature vector, and obtaining the first inferred type of the target road segment; obtaining the connection angle between the target road segment and its neighboring road segment from the topological structure data of the road network; obtaining the second inferred type of the target road segment based on the obtained connection angle and the type of the neighboring road segment; adopting the integrated algorithm to compute the final inferred type according to the first inferred type and the second inferred type. The present embodiment considers both the driving trajectory data of the plurality of vehicles and the topological structure data of the road network, so that the accuracy of the present invention is high, and inferred result is more accurate. Meanwhile, the present embodiment also considers the restrict relationship between the types of two connecting road segments, obtains the final inferred type by integrating two preliminary inferred results, so the accuracy of the present invention is higher.

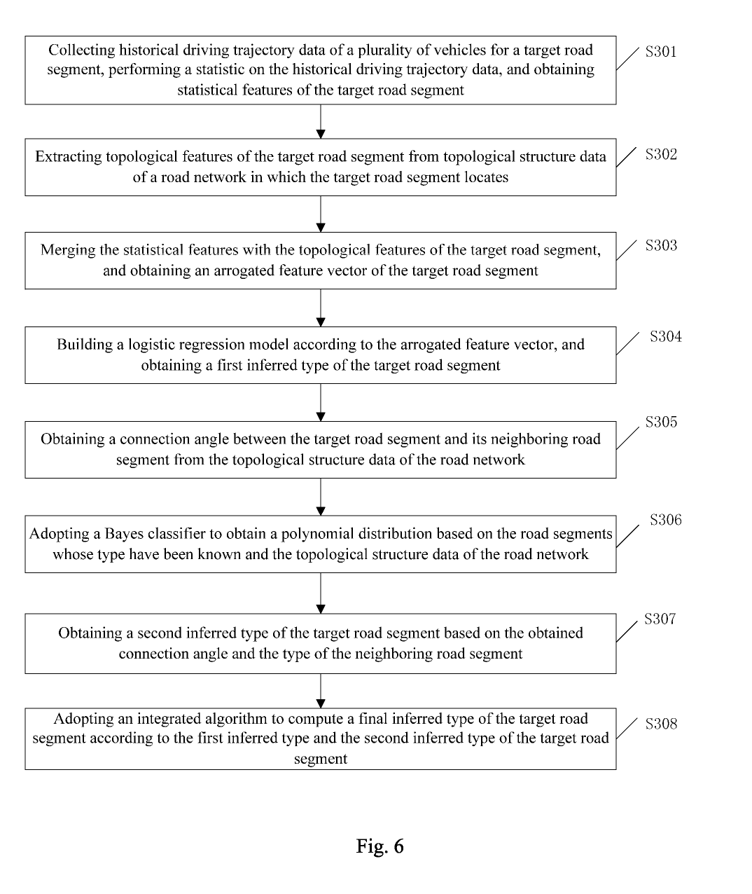

FIG. 6 is a flowchart of a method for inferring a type of a road segment according to another embodiment of the present invention. As shown in FIG. 6, this method comprises the steps of:

S301: Collecting historical driving trajectory data of a plurality of vehicles for a target road segment, performing a statistic on the historical driving trajectory data, and obtaining statistical features of the target road segment.

Concretely, the S301 comprises the steps of: collecting the historical driving trajectory data of a plurality of vehicles for the target road segment; adopting the ST-Matching algorithm to match the historical driving trajectory data of onto the road network, and obtaining the historical driving trajectory data for the target road segment; performing the statistic on the historical driving trajectory data of the target road segment, thereby obtaining statistical features of the target road segment.

A road segment is the carriageway between two intersections. An expressway or a large avenue may have two different road segments between two intersections, because they are different directions with limited-access.

Wherein, the a plurality of vehicles specifically refers to a plurality of taxis. It is understandable, the vehicles can also be other types of cars, such as buses, private vehicles and so on. Since it is private and difficult to obtain private vehicle data, this embodiment uses the historical trajectories of taxis. A trajectory is represented as a series of sample points, wherein the sampling rate is around 20 seconds. As shown in FIG. 2, the data of each sample point includes taxi ID, timestamp, latitude/longitude, speed, angle, and status. Wherein, the taxi ID is the taxi registration plate number; the timestamp is timestamp of the sample point; the latitude/longitude is the GPS location of the sample point; the speed is the current speed of the taxi while sampling; the angle is the current driving direction of the taxi while sampling; the status is the indicator of whether the taxi is occupied or vacant.

Wherein, the GPS location of the sample point is represented as a latitude-longitude pair with timestamp, without any road network information. Hence, we have to map the trajectories onto the road network via map matching. The present embodiment uses the method ST-Matching proposed in Page 352˜361 of International Journal of Geographical Information Science (2009). ST-Matching considers both the spatial topological structure of the road network, and the temporal features of the trajectories. ST-Matching is suitable to handle low-sampled trajectories, such like the taxi trajectories in this embodiment.

After mapping the historical trajectories onto the road network, obtains the data of sample points that belongs to the target road segment. Then performs a statistic of the data of sample points, and obtains the statistical features of the target road segment. Wherein, the statistical features include an average speed of occupied taxis, a density of occupied taxis, a density of vacant taxis, and the number of pick-up events. That is, the statistical features of the target road segment are got by doing statistics of the taxi ID, timestamp, latitude/longitude, speed, angle, and status of a set of sample points.

S302: Extracting topological features of the target road segment from topological structure data of a road network in which the target road segment locates.

Wherein, the topological structure data of road network has been known. A road network {τᵢ}ᵢ₌₁ⁿ consists of a set of road segments, where τᵢ is road segment i. This invention uses a connectivity matrix M^{n×n} to represent the topology of the road network, where mᵢⱼ∈M is the normalized angle between road segments i and j if they are connected, and 0 otherwise.

Wherein, the topological features of the target road segment include length of road segment, cumulative flutter value, neighbors, and adjacent road segments. Wherein, length of road segment and cumulative flutter value can effectively show the type of a road segment. For example, a large avenue is often limited-access, and there are few intersections within it during a long distance. Hence, a road segment with long length is more likely to be a large avenue, or an expressway. Similarly, a road segment is more likely to be a large avenue when it is straighter, and less when it is twisted, based on our experience. Hence, this invention uses cumulative flutter value to show the types of road segments. For the neighbors, it is considered that two road segments are neighbors when they are topologically connected. If a road segment has a plurality of neighbors, it is less likely to be a large avenue, because a large avenue, or an expressway, often has one or two neighbors as the entrance/exit of it. For the adjacent road segments, “adjacent” is defined as the distance between two road segments is less than a preset threshold (specially a small distance, such as 10 meters). The distance of two road segments is calculated via the average distance between each vertex of the polylines of the road segments. As shown in FIG. 3, τ₁ is the road segment 1, τ₂ is the road segment 2. The distance between the vertexes of two road segments are d₁, d₂, d₃, then the average of d₁, d₂, d₃ is the distance of two road segments. Two adjacent road segments may have the same type especially when they have opposite directions.

S303: Merging the statistical features with the topological features of the target road segment, and obtaining an arrogated feature vector of the target road segment.

Specifically, the statistical features and the topological features constitute the arrogated feature vector. Since the size of the collected data may be large, the dimensionality of the arrogated feature vector may be large. So after the step S303, the invention can further include the step: adopting a principal component analysis to reduce the dimensionality of the arrogated feature vector, and obtaining the principal components of the arrogated feature vector.

S304: Building a logistic regression model according to the arrogated feature vector, and obtaining a first inferred type of the target road segment.

Wherein, the types of road segments are defined according to the regulations of the national standard. As shown in FIG. 4, the types of road segments include 7 types. Wherein the first inferred type is the outputted result of the logistic regression model, which is just a preliminary result.

However, if there is only a small moment of arrogated feature vector data, the first inferred type may not be very accurate, so the present embodiment adopts the connection angle as a basis.

S305: Obtaining a connection angle between the target road segment and its neighboring road segment from the topological structure data of the road network.

Generally, it is observed that the type of a particular road segment has a strong indication of the possible types that its neighboring road segments can take, depending on the connection angle. The connection angle of two neighboring road segments highly determines the relation of the types of these two road segments. For example, in a common urban road network, if two road segments have an angle of 180°, they are often the same road with the same road name. When the angle becomes smaller, like 90°, they are often two different roads with different road names.

S306: Adopting a Bayes classifier to obtain a polynomial distribution based on the road segments whose type have been known and the topological structure data of the road network.

Wherein, the polynomial distribution represents the probability distribution of a road segment type by a function that depends on the connection angle between the road segment and its neighboring road segment and the type of its neighboring road segment. Specifically, the polynomial distribution represents the probabilities that the type of a road segment is one of the types 1˜7 shown in FIG. 4 as the connection angle between the road segment and its neighboring road segment varies and the type of its neighboring road segments varies.

S307: Obtaining a second inferred type of the target road segment based on the obtained connection angle and the type of the neighboring road segment.

Specifically, the S307 includes steps of: adopting Bayesian algorithm to compute the second inferred type by using the polynomial distribution according to the obtained connection angle and the type of the neighboring road segment of target road segment.

S308: Adopting an integrated algorithm to compute a final inferred type of the target road segment according to the first inferred type and the second inferred type of the target road segment.

Wherein, the integrated algorithm is an algorithm that integrates the inferred results. In the present embodiment, the integrated algorithm is any one of Stacked generalization algorithm, Support Vector Machine algorithm and random forests algorithm. The final inferred type is obtained by synthesizing the first inferred type and the second inferred type.

The present embodiment provides a method for inferring a type of a road segment, comprising the steps of: collecting the historical driving trajectory data of the plurality of vehicles for the target road segment, performing the statistic on the historical driving trajectory data, and obtaining the statistical features of the target road segment; extracting the topological features of the target road segment from the topological structure data of the road network; merging the statistical features with the topological features of the target road segment, and obtaining the arrogated feature vector of the target road segment; building the logistic regression model according to the arrogated feature vector, and obtaining the first inferred type of the target road segment; obtaining the connection angles between the target road segment and its neighboring road segments from the topological structure data of the road network; adopting a Bayes classifier to learn and thus to obtain a polynomial distribution based on a road segment whose type have been known and the topological structure data of the road network; obtaining the second inferred type of the target road segment based on the obtained connection angle and the type of the neighboring road segment; adopting the integrated algorithm to compute the final inferred type according to the first inferred type and the second inferred type. The present embodiment considers both the driving trajectory data of the plurality of vehicles and the topological structure data of the road network, so that the accuracy of the present invention is high, and the inferred result is more accurate. Meanwhile, the present embodiment also considers the restrict relationship between the types of two connecting road segments, obtains the final inferred type by integrating two preliminary inferred results, so the accuracy of the present invention is higher.

The embodiments of the present invention are described in a progressive way. Every embodiment focuses on the difference from other embodiments. The same and similar parts can be referred to by each other.

The professionals can further realize that, the algorithm step of each embodiment can be realized in electronic hardware, computer software, or a combination of both. In order to clearly illustrate the interchangeability of hardware and software, the step has been described in general functions in the above statement. That the functions will be performed in hardware or software way depends on the design constraints of specific applications in technology solutions. Professionals can use different methods to achieve the described function, but this implementation should not be considered out the range of invention

The algorithm steps of each embodiment can be implemented by hardware, the software module of the processor, or a combination of both. Software module can be placed in RAM, memory, ROM, programmable ROM, electrically erasable programmable ROM, registers, hard disk, removable disk, CD-ROM, or in any other form of storage media in the known technical field.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

What is claimed is:

1. A method for inferring a type of a road segment, comprising the steps of:
collecting historical driving trajectory data of a plurality of vehicles for a target road segment, performing a statistic on the historical driving trajectory data, and obtaining statistical features of the target road segment;
extracting topological features of the target road segment from topological structure data of a road network in which the target road segment locates ;
merging the statistical features with the topological features of the target road segment and obtaining an arrogated feature vector of the target road segment; and
building a logistic regression model according to the arrogated feature vector and obtaining a first inferred type of the target road segment.

2. The method according to claim 1, wherein after the steps of building the logistic regression model according to the arrogated feature vector and obtaining the first inferred type of the target road segment, the method further comprises the steps of:
obtaining a connection angle between the target road segment and its neighboring road segment from the topological structure data of the road network; and
obtaining a second inferred type of the target road segment based on the obtained connection angle and the type of the neighboring road segment.

3. The method according to claim 2, wherein after obtaining the second inferred type of the target road segment, the method further comprises the step of:
adopting an integrated algorithm to compute a final inferred type of the target road segment according to the first inferred type and the second inferred type of the target road segment.

4. The method according to claim 1, wherein the steps of collecting historical driving trajectory data of the plurality of vehicles for the target road segment, performing the statistic on the historical driving trajectory data, and obtaining the statistical features of the target road segment comprise the steps of:
collecting historical driving trajectory data of the plurality of vehicles;
adopting a ST-Matching algorithm to match the historical driving trajectory data onto the road network, and obtaining the historical driving trajectory data of the target road segment; and
performing the statistic on the historical driving trajectory data of the target road segment, thereby obtaining the statistical features of the target road segment.

5. The method according to claim 1, wherein after the steps of merging the statistical features with the topological features of the target road segment and obtaining the arrogated feature vector of the target road segment, the method further comprises the steps of:
adopting a principal component analysis to reduce the dimensionality of the arrogated feature vector, and obtaining principal components of the arrogated feature vector.

6. The method according to claim 2, wherein after the step of obtaining the connection angle between the target road segment and its neighboring road segment from the topological structure data of the road network, the method further comprises the step of:
adopting a Bayes classifier to learn and thus to obtain a polynomial distribution based on a road segment whose type have been known and the topological structure data of the road network; wherein the polynomial distribution represents the probability distribution of a road segment type by a function that depends on the connection angle between the road segment and its neighboring road segment and the type of its neighboring road segment.

7. The method according to claim 6, wherein the step of obtaining the second inferred type of the target road segment based on the obtained connection angle and the type of the neighboring road segment comprises the step of:
adopting Bayesian algorithm to compute the second inferred type by using the polynomial distribution according to the obtained connection angle and the types of the neighboring road segment of the target road segment.

8. The method according to claim 3, wherein the integrated algorithm is any one of Stacked generalization algorithm, Support Vector Machine algorithm and random forests algorithm.

9. The method according to claim 1, wherein the plurality of vehicles refer to a plurality of taxis; and the statistical features comprise an average speed of occupied taxis, a density of occupied taxis, a density of vacant taxis, and the number of pick-up events.

10. The method according to claim 1, wherein the topological features of the target road segment comprise a length of the road segment, a cumulative flutter value, neighboring road segments of the road segment and adjacent road segments of the road segment.
